(19) United States
(12) Patent Application Publication
(10) Pub. No.: US 2007/0241135 A1
(43) Pub. Date: Oct. 18, 2007

(54) Unit for Dispensing Fluids or Mixtures and Dispensing Device

(75) Inventor: Stefano Santagiuliana, Caldogno (IT)

Correspondence Address: BIRCH STEWART KOLASCH & BIRCH, PO BOX 747, FALLS CHURCH, VA, 22040-0747, US

(73) Assignee: Taplast Spa, Dueville (VI) (IT)

(21) Appl. No.: 11/631,933

(22) PCT Filed: Jul. 5, 2005
(86) PCT No.: PCT/IB05/01901

§ 371 Date: May 9, 2007

(30) Foreign Application Priority Data
Jul. 9, 2004 (IT) VI2004A000169

(51) Int. Cl. B67D 5/00; B67C 9/00; B67D 5/58; G01F 11/00; B67D 5/40

(52) U.S. Cl. 222/153.13; 222/190; 222/321.9; 222/384

(57) ABSTRACT

A liquid dispensing pump for a portable container in which the pump piston is disposed for lost motion in the pump cylinder between the plunger rod and a discharge valve carried by a stem affixed to the plunger rod and extending through the piston. The piston has upwardly and downwardly presented elastomeric skirts of which the lower skirt seats against the discharge valve on the piston upstroke and the upper skirt seats against a venting valve at the termination of the upstroke. Both the discharge valve and the venting valve exert an expanding action on the respective piston skirts incident to their seating relation with the skirts under the resilient pressure of the pump spring, to counteract any shrinking tendency of the skirts, and means are provided for limiting the expansion of the skirts. The upper and lower ends of the piston are symmetrically arranged to permit reversal of its position in the pump.

The invention concerns a unit for dispensing a fluid, to be applied to a container containing said fluid, particularly suited to dispense food substances, perfumes or detergents in general, and a relevant dispensing device.

As already known, dispensing devices that are applied to the container of the product in question are widely used to dispense liquid or creamy products, like food substances, soaps, creams, detergents or perfumes.

Said devices substantially comprise a cap provided with means for connection to the neck of the container and one unit for dispensing the liquid contained in the container, comprising a hollow body defining a liquid suction/compression chamber, to which a plunger is slidingly coupled.

The plunger is provided with first connection means suited to be coupled with second connection means belonging to a rod which is provided with an actuator element that can be operated by the user.

Said connection means, which allow the unit to be assembled, even automatically, are generally of the so-called “snap” type and comprise annular edges made on the plunger and suited to be engaged with corresponding annular seats made on the rod.

The unit also comprises elastic means, constituted for example by a metal helical spring, which ensure the automatic return of the plunger to the rest position once the fluid has been dispensed.

A first drawback of these fluid dispensing units and of the relevant devices is represented by the fact that the connection carried out by said connection means is not reliable.

In fact, it has been observed that a limited traction force exerted by the user on the actuator causes the detachment of the plunger from the rod, with clear consequent inconveniences that may also cause irreparable damage to the unit and the device.

The drawback described above is particularly felt also in reference to the increasingly higher quality and operating standards required for dispensing units and the relevant devices.

The traction force that can be borne by the above mentioned connection means is in fact limited and much lower than the force that can be exerted by a user.

The aim of the present invention is to overcome the drawbacks described.

In particular it is a first aim of the invention to produce a unit for dispensing fluids or mixtures and a relevant device that have the same characteristics as the units and devices of the known type, but are more reliable than said units and devices.

Another aim of the invention is to produce a unit and a relevant device with more resistance to the disengagement of the plunger from the rod compared to equivalent units and devices of the known type.

A further aim of the invention is to propose a unit that can be used to produce any device for dispensing fluids or mixtures even in the form of foam, like for example the dispensing devices called foamers.

It is a further aim of the invention to propose a unit to be used to produce devices for dispensing liquids, advantageously, but not exclusively, detergent or food liquids.

It is a further aim of the invention to carry out a dispensing device that can be locked/released by the user.

It is another aim of the invention to carry out a device that also allows the user to select in advance a specific quantity of fluid to be dispensed.

It is a further aim of the invention to carry out a device that is more resistant to any incorrect uses.

It is a further aim of the invention to carry out a device for dispensing fluids where the quantity to be dispensed is predetermined upon its assembly or upon application to the container or before use.

It is another, yet not the least aim of the invention to carry out a unit and a relevant device that are economic and easy to use, as well as easy to construct and to assemble and suited to be produced in series.

The aims described above have been achieved through the implementation of a unit for dispensing fluids that, according to the main claim, comprises:
at least one hollow body defining at least one suction/compression chamber of said fluid, to which at least one plunger is slidingly coupled;
at least one rod provided with first connection means suited to be coupled with second connection means integral to said at least one plunger;
at least one actuator element integral to said at least one rod to allow said unit to be operated;
   and is characterized in that said unit for dispensing fluids also comprises means suited to prevent the disengagement of said first connection means from said second connection means when an axial traction is exerted on said at least one actuator element and/or on said at least one rod.

The aims described above are achieved also through the implementation of a device for dispensing fluids according to claim 35, as well as of a device for dispensing fluids in the form of foam according to claim 36.

The proposed solution advantageously makes it possible to produce units and devices that are not damaged when a traction force is exerted on the actuator and/or on the rod.

Still advantageously, the solution proposed guarantees that the disengagement of the connection means cannot take place accidentally, but only through the disassembly of the unit and relevant device.

The aims and advantages described above will be highlighted in greater detail in the description of some preferred embodiments of the invention, given indicatively as examples without limitation, with reference to the enclosed drawings, wherein:

FIG. 1 shows a longitudinal cross section of a possible embodiment of a device including a unit according to the invention;

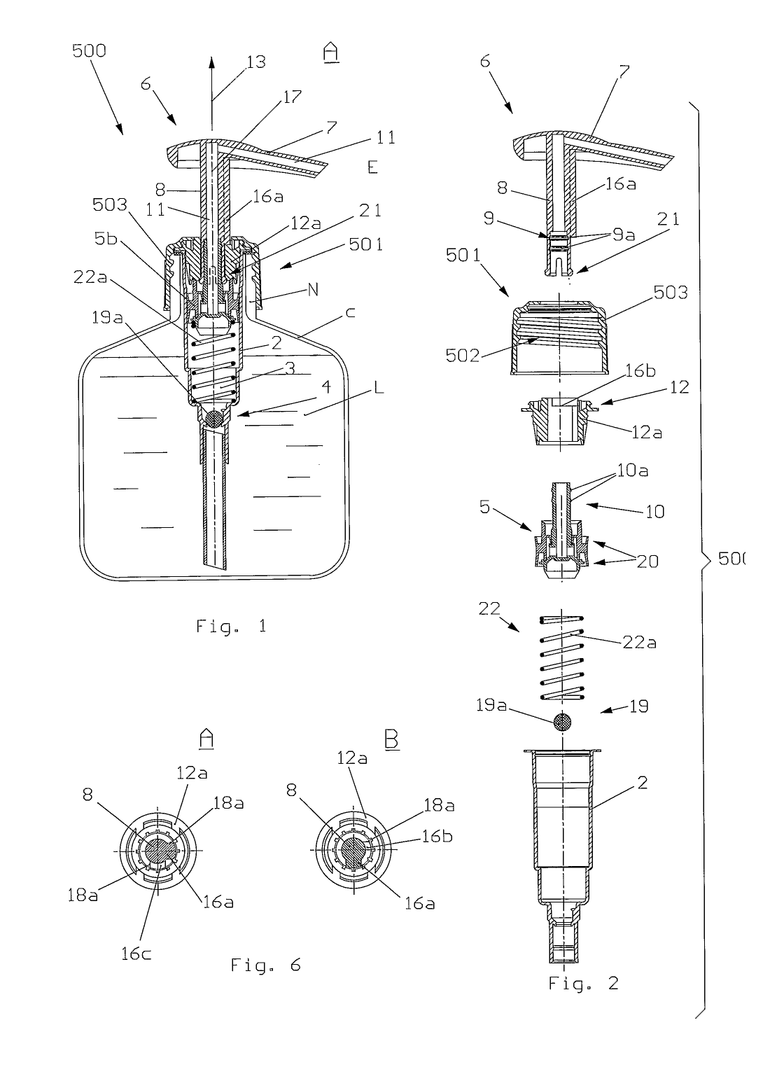

FIG. 2 shows a longitudinal cross section and an exploded view of the device shown in FIG. 1;

FIG. 3 shows a longitudinal cross section of the unit shown in FIG. 1;

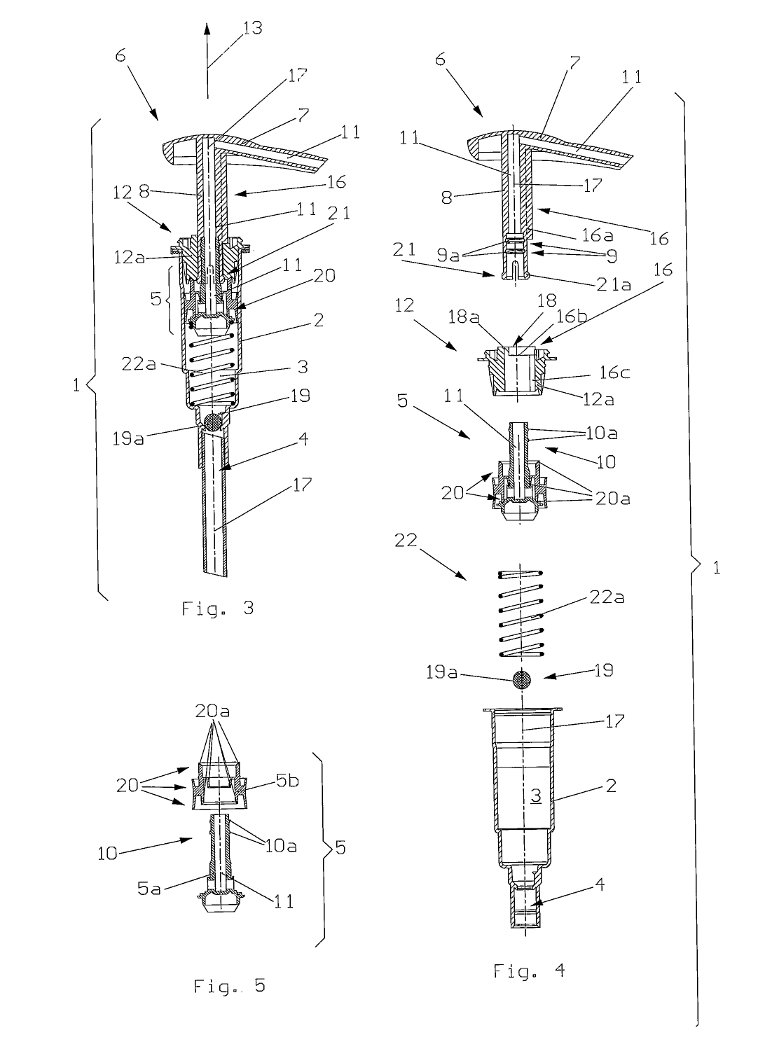

FIG. 4 shows a longitudinal cross section and an exploded view of the unit shown in FIG. 3;

FIG. 5 shows a longitudinal cross section and an exploded view of some parts of the unit shown in FIG. 3;

FIG. 6 shows two plan and section views of some parts of the unit shown in FIG. 3, in different operating configurations;

FIG. 7 shows a longitudinal cross section of another example of embodiment of a device comprising a unit according to the invention;

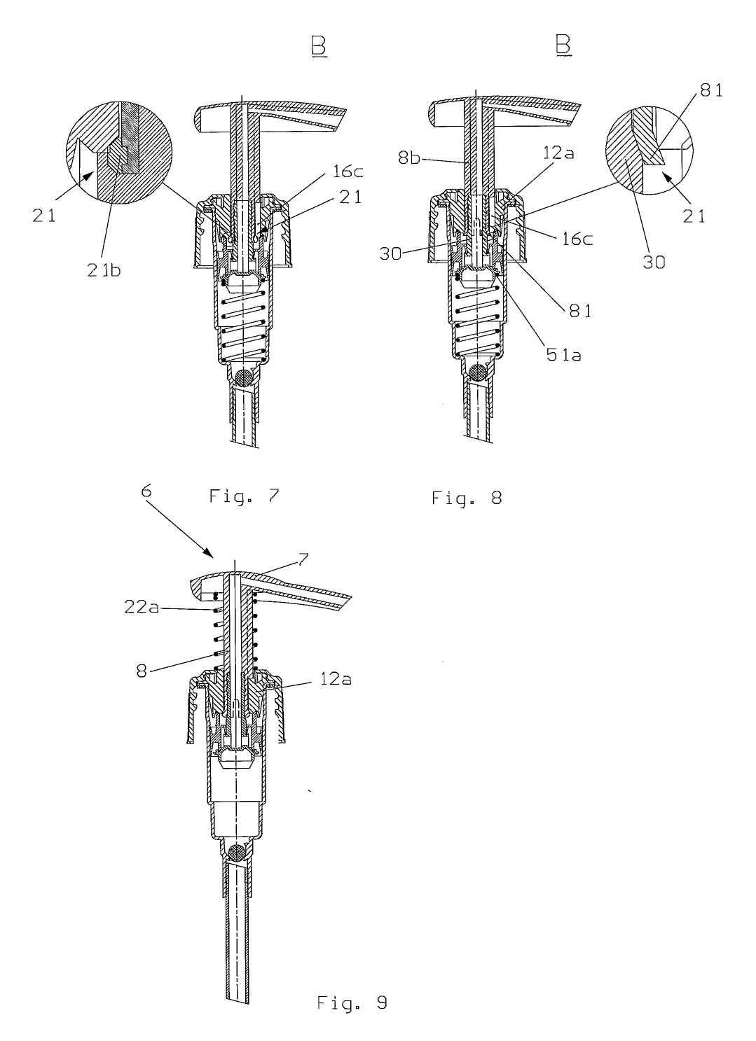

FIG. 8 shows a longitudinal cross section of a further example of embodiment of a device comprising a unit according to the invention;

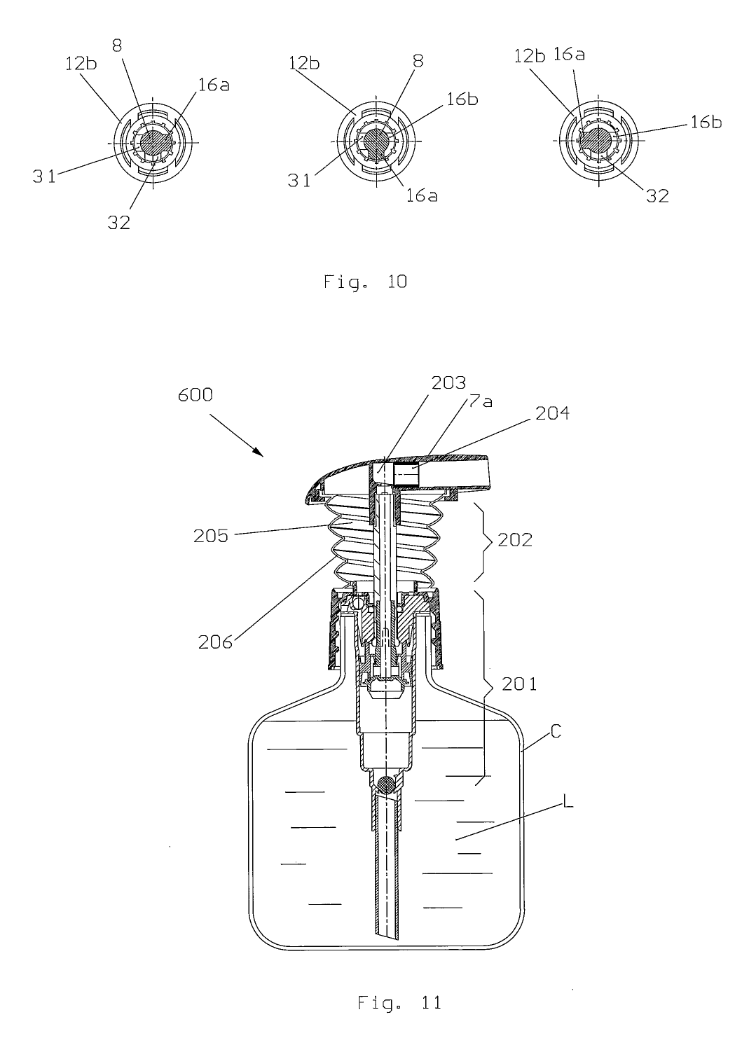

FIG. 9 shows a longitudinal cross section of a further example of embodiment of a device comprising a unit according to the invention;

FIG. 10 shows three plan and section views of a construction valiant of some parts of the unit and of the device shown in FIG. 1, in three operating configurations;

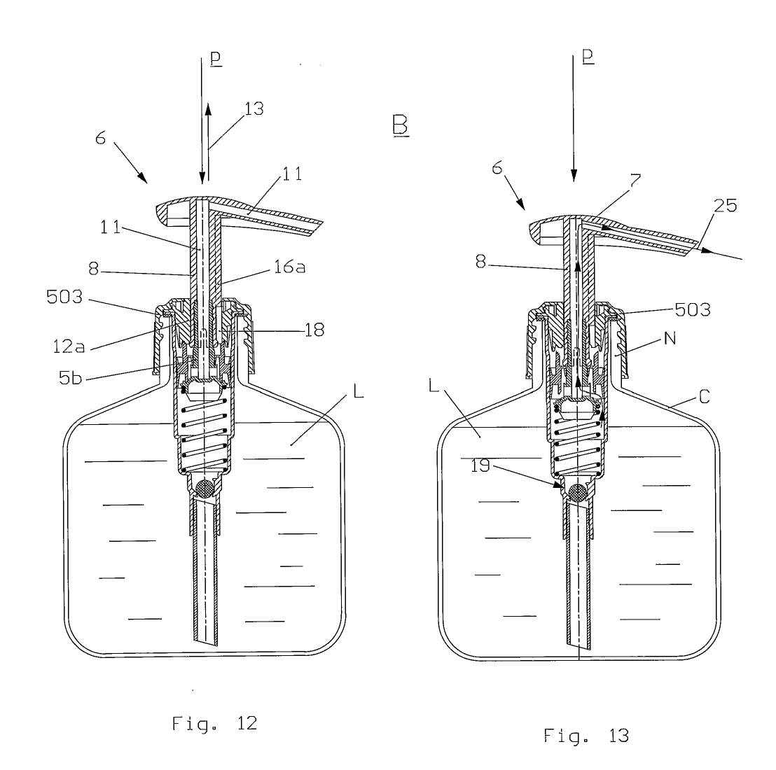

FIG. 11 shows a longitudinal cross section of a device for dispensing fluids in the form of foam according to the invention;

each of FIGS. 12 and 13 shows a longitudinal cross section of the unit and of the device shown in FIG. 1, in the same number of operating positions.

The examples of embodiment of the invention described below refer to units for dispensing fluids and to the relevant devices, in particular for dispensing detergent fluids. It is clear that the solution proposed can be applied also to units and devices for dispensing perfumes or food products, or any other fluid in general, which must be drawn from a container and conveyed towards the outside even in the form of foam or spray.

An embodiment of a unit for dispensing fluids together with the relevant device, subject of the present invention, applied to the neck N of a container C containing a fluid L to be dispensed is shown in the Figures from 1 to 4.

More precisely, the dispensing device indicated as a whole by 500 in FIGS. 1 and 2 comprises a support element 501 for a suction/dispensing unit 1, shown in detail in FIGS. 3 and 4, provided with means 502 for fastening to the neck N of the container C.

In the case in question the support element 501 comprises a cap or metal ring 503 and the fastening means 502 are constituted by a thread suited to be coupled to a corresponding thread made on the neck N.

The unit 1, shown in detail in FIGS. 3 and 4, is suited to draw the fluid L, in this case a detergent liquid, from the container C, in order to convey it towards the outside E.

It comprises a hollow body 2 which defines a suction/compression chamber 3 of the liquid L, provided with a suction duct 4 for the liquid L, to which a plunger 5 is slidingly coupled.

The unit 1 can be operated by the user through an actuator element 6, comprising a button or spout or nozzle 7 integral with a rod 8 that, in the case in question, is made in a single block with the nozzle 7 itself.

The rod 8 is provided with first connection means 9 suited to be coupled with second connection means 10 integral with the plunger 5.

The rod 8 and the nozzle 7 are internally provided with a dispensing duct 11 for the liquid L, communicating with the suction/compression chamber 3 and with the outside E.

The unit 1 also comprises means, indicated as a whole by 12, suited to hinder/prevent the disengagement of the first from the second connection means 9 and 10 when an axial or traction force is exerted on the actuator element 6 and/or on the rod 8 in the direction indicated by number 13.

Said means 12 cooperate with the neck N of the container C and are arranged outside the rod 8 and in correspondence with the connection means 9, 10 at least when the traction force is exerted.

In the case in question said means 12 comprise an annular body or metal ring 12a that prevents the rod 8 from elastically deforming due to the action of the traction force 13, thus also preventing the disengagement of the connection means 9, 10. Regarding the plunger 5 shown in detail in FIG. 5, it comprises a support element 5a to which a piston body 5b is slidingly coupled, said piston body tightly cooperating with the walls of the chamber 3.

The support element 5a is provided at one end with said second connection means 10 that, in the case in question, comprise two annular edges 10a suited to be engaged into corresponding annular seats 9a and visible in FIG. 4, made at one end of the rod 8 and constituting, in the case in question, the first connection means 9.

In other embodiments of the invention the edges are made on the rod 8 and the annular seats on the support element 5a.

In other embodiments mixed solutions are provided.

The unit 1 also comprises means for locking/releasing the unit 1 itself, indicated as a whole by 16 and visible in FIG. 4, made, in the case in question, in the annular body 12a.

More precisely, said means 16 are suited to prevent or allow the operation of the unit 1 and can be activated by selectively turning the actuator element 7 on a longitudinal axis 17 from a first predefined locking position A, shown in FIG. 1, to a second predefined operating position B, shown in FIGS. 12 and 13. The locking/releasing means 16 comprise a first opposing element constituted by a projecting element 16a that is integral with the rod 8, visible in FIG. 4, suited to selectively interfere with a second opposing element belonging to the annular body 12a, visible also in FIG. 6.

In the case in question said second opposing element comprises an horizontal plane 16b that interferes with the element 16a, thus locking the axial movement of the plunger-rod-actuator unit. The horizontal plane 16b is interrupted by a vertical groove 16c on which the projecting element 16a can slide due to the action of the user to allow the movement of the plunger 5.

The two extreme angular positions A and B that the actuator element 6 can assume, visible in FIGS. 1, 6 and 12, are determined by stopping means 18 constituted in the case in question by third opposing elements comprising two vertical planes 18a jointed with the horizontal plane 16b and suited to counteract said first opposing elements 16a to prevent any further rotation of the actuator element 7.

First and second valve means 19 and 20, located upstream and downstream the suction duct 4 and the dispensing duct 11, respectively, regulate the flow of the liquid L from the container C to the suction/compression chamber 3 and the flow from the chamber 3 itself to the dispensing duct 11.

In the example of embodiment represented, the first valve means 19 comprise a ball 19a in a non-metallic material, while the second valve means 20 are constituted by sealing edges 20a belonging to the piston body 5b suited to be engaged with corresponding grooves obtained on the annular body 15a and on the support element 5a.

It is important to observe that the unit also comprises means 21 suited to prevent the traction force 13 exerted on the actuator 6 and/or the rod 8 from being transmitted to said second valve means 20, thus negatively affecting their functionality.

In the case in question said means 21, visible in FIG. 4, comprise an annular edge 21a carried out at the end of the rod 8 that interferes with the annular body 12a.

The unit 1 also comprises elastic means 22 interposed between the hollow body 2 and the plunger 5, said elastic means ensuring the return of the plunger 5 to the rest position once the fluid has been dispensed.

Said elastic means 22 comprise, in the case in question, a metal helical spring 22a housed in the chamber 3 and having one end against the support element 5a and the other end against the bottom wall of the chamber 3.

In other embodiments said elastic means 22 may also be constituted by equivalent elements such as, for example, an elastic bellows made of a plastic material.

A construction variant of the unit subject of the invention and of the relevant device, represented in FIG. 7, is differentiated from the previous one due to the fact that the means 21 suited to prevent the traction force 13 from being transmitted to the valve means 20 comprise an annular element 21b suited to be inserted into a corresponding annular seat obtained near the end of the rod 8a.

A further construction variant of the unit subject of the invention and of the relevant device, represented in FIG. 8, is differentiated from the previous one due to the fact that the same means 21 are constituted by the end 81 of the rod 8b itself. More precisely, according to said construction variant the support element 51 is provided with an annular projection 30 suited to deform the end 81 of the rod 8b and thus enlarge the cross section of the rod 8b itself, in such a way as to prevent sliding on the annular body 12a that guides it.

Another construction variant of the unit subject of the invention and of the relevant device, represented in FIG. 9, is differentiated from the previous one due to the fact that the helical spring 22a is coaxial to the rod 8 and positioned between the body 12a and the spout or nozzle 7.

A further construction variant is differentiated from the previous ones due to the fact that the unit and the relevant device can be configured in such a way as to dispense different and precise quantities of fluid L each time they are operated, by selectively turning the actuator element 6.

According to this embodiment the annular body 12b, shown in detail in FIG. 10, is provided with two longitudinal grooves 31 and 32 having different length, on which the opposing element 16a slides. Each groove ends with a corresponding horizontal plane that delimits the plunger stroke and therefore the quantity of liquid dispensed.

In this case the user, before operating the device, must first turn the actuator element 6 to the position corresponding to the quantity of liquid to be dispensed and properly indicated on the cap.

A further construction variant of the unit subject of the invention, not represented, and of the relevant device is differentiated from the previous one owing to the fact that the piston rod is coupled externally to the end of the support element.

Another construction variant of the unit subject of the invention, not represented, is differentiated from the previous one due to the fact that also the second valve means 20 are constituted by a spherical element made of a plastic material.

A farther construction variant of a device produced according to the invention, indicated as a whole by 600 in FIG. 11, is differentiated from the previous ones due to the fact that it is suited to dispense the liquid L contained in the container C in the form of foam.

In this case the dispensing device comprises two dispensing units, indicated by 201 and 202, respectively, that can be operated in a coordinated way by the user through the actuator element 7a.

A first unit 201 is suited to draw the liquid L from the container C to convey it to a mixing chamber 203, while a second unit 202 is suited to convey, at the same time, pressurised air to the same mixing chamber 203, after which there are means suited to provide for the formation of foam.

More precisely, said means are positioned before the outlet of the device and comprise a porous partition 204 suited to facilitate the formation of foam.

In the case in question the second unit 202 comprises a collapsible chamber 205 defined by an elastic bellows 206 that in this case replaces also the helical spring.

The embodiment of FIG. 11 is differentiated from the previous ones also owing to the fact that the spout or nozzle 7a is removably connected to the rod. This makes it possible to carry out the device 600 so that it can be configured with actuators having different shape and/or colour.

A further construction variant not represented is differentiated from the previous one owing to the fact that also the second air suction/compression unit 202 is carried out with a hollow body to which a plunger is slidingly connected.

The operation of the device subject of the invention is described with reference to the first embodiment represented in FIG. 1, since a comparison with the other devices described does not show any substantial differences.

From an operative point of view, the user first turns the actuator 6 in such a way as to set the device 1 to the desired operating mode.

More precisely, to lock the device 1 the user turns the spout or nozzle 7 on the axis 17 until it reaches position A, shown in detail in FIGS. 1 and 6. In this position the first opposing elements 16a face the horizontal plans 16b. This prevents any axial movement of the actuator-rod-plunger unit.

Vice versa, to operate the device 1 the user turns the spout or nozzle 7 on the axis 17 until it reaches position B, shown in FIGS. 6, 12 and 13. In this position the first opposing elements 16a face the groove 16c, along which they can slide freely, thus allowing the piston body 5b to move axially under the pressure P exerted by the user on the actuator 6.

In this way the user exerts pressure on the elastic means 22 and compresses the product contained in the suction/compression chamber 3.

The increase in pressure makes the piston body 5b slide on the support element 5a, thus ensuring the flow of the liquid L contained in the suction/compression chamber 3 first towards the dispensing duct 11 and then towards the outside E, following the course indicated by 25, shown in FIG. 13.

The piston body 5b, once it has reached the bottom of the suction/compression chamber 3, is released by the user, thus allowing the elastic means 22 to bring it back to its initial rest position shown in FIG. 12.

The elastic return of the plunger 5 generates a vacuum inside the suction/compression chamber 3 and said vacuum causes the operation of the first valve means 19 downstream the suction duct 4 and makes the liquid L flow into the chamber itself, by sucking it from the container, thus preparing the unit 1 and the device 500 for the successive use.

The application of a traction force 13 on the actuator 6 and/or on the rod 8 for example by the user causes the engagement of the connection means 9 and 10.

In particular, said force tends to disengage the rod 8 from the plunger 5, and more precisely it tends to enlarge the rod 8 in correspondence with the connection means 9 and 10 until ensuring the release of the projecting elements 10a from the corresponding seats 9a.

This movement, however, is advantageously opposed by the annular body 12 that, though allowing the rod 8 to be slightly enlarged, which is necessary to guarantee the sliding movement of the same, limits its freedom of movement, thus avoiding any damage to the unit 1 and the device 500.

It should also be observed that said annular body 12a cooperates with the walls of the neck N of the container C and with the cap or metal ring 503. In particular, the neck N and the metal ring 503 guarantee that the annular element 12 does not deform, thus contributing to prevent the disengagement of the connection means 9, 10.

This prevents the disengagement of the connection means 9, 10, making it impossible to damage the unit and the device.

It should also be observed that, in the represented embodiments of the invention, when the traction force 13 is exerted the means 12 are positioned in correspondence with the connection means 9, 10.

In other embodiments said means 12 are always positioned in correspondence with the connection means 9, 10.

Advantageously and preferably, the unit 1 and the relevant device proposed can be carried out in all their parts also in a plastic or synthetic material. This allows a completely recyclable unit and device to be obtained, with no need to previously separate parts in metallic materials or in any way incompatible materials.

The above description clearly shows that the solution proposed allows the drawbacks described to be eliminated.

It should also be observed that the proposed solution advantageously makes it possible to produce devices for dispensing fluids that can be assembled automatically.

Even though the invention has been described with reference to the enclosed drawings, upon implementation certain modifications may be made, which are all included in the inventive concept expressed in the following claims and are therefore protected by the present patent.

1) A unit for dispensing fluids comprising:
at least one hollow body defining at least one suction/compression chambers of said fluid, to which at least one plungers is slidingly coupled;
at least one rod provided with first connection means suited to be coupled to second connection means integral with said at least one plunger;
at least one actuator element integral with said at least one rod to allow said unit to be operated,
wherein said unit for dispensing fluids further comprises means suited to prevent the disengagement of said first connection means from said second connection means when an axial traction is exerted on said at least one actuator element and/or on said at least one rod.

2) The unit according to claim 1, wherein said means suited to prevent the disengagement of said first connection means from said second connection means are arranged externally or coaxially to said at least one rod.

3) The unit according to claim 1, wherein said means suited to prevent the disengagement of said first connection means from said second connection means are positioned in correspondence with said first and said second connection means, at least when said axial traction is exerted.

4) The unit according to claim 1, wherein said means suited to prevent the disengagement of said first connection means from said second connection means comprise at least one annular body.

5) The unity according to claim 1, wherein said at least one plunger comprises at least one support element provided with said second connection means to which a piston body is slidingly coupled, and wherein said piston body sealingly cooperates with the walls of at least one suction/compression chamber.

6) The unit according to claim 1, wherein said rod is provided with at least one dispensing duct of the fluid communicating with said at least one suction/compression chamber and with the outside.

7) The unit according to claim 6, wherein said unit also comprises first and second valve means, located upstream and downstream of a suction duct and said dispensing duct, respectively, suited to regulate the flow of said fluid into said suction/compression chambers and the flow from said chamber itself to the dispensing duct.

8) The unit according to claim 7, wherein said first valve means comprise a ball made of a non-metallic material.

9) The unit according to claim 7, wherein said second valve means comprise sealing edges belonging to said plunger suited to be engaged with corresponding grooves.

10) The unit according to claim 7, wherein the second valve mean comprise a spherical element made of a non-metallic material.

11) The unit according to claim 7, wherein said unit also comprises means suited to prevent the traction force exerted on the actuator and/or on said rod from being transmitted to said second valve means.

12) The unit according to claim 11, wherein said means comprise an edge (21a) belonging to said at least one rod.

13) The unit according to claim 11, wherein said means comprise an annular element suited to be fitted into a corresponding annular seat obtained near the end of said at least one rod.

14) The unit according to claim 11, wherein said means comprises the end of said rod.

15) The unit according to claim 14, wherein said at least one plunger comprises a projection suited to deform at least one part of said end of said rod, in such a way as to enlarge the cross section of said rod.

16) The unit according to claim 1, wherein said unit also comprises means to lock/release said unit that can be operated by selectively turning said at least one actuator element.

17) The unit according to claim 16, wherein said locking/releasing means comprise a first opposing element integral with said rod suited to selectively interfere with a second opposing element integral with said means suited to prevent the disengagement of said first connection means from said second connection means.

18) The unit according to claim 12, wherein said first opposing element comprises at least one projecting element and said second opposing element comprises at least one horizontal plane.

19) The unit according to claim 18, wherein said at least one horizontal plane is interrupted by a vertical grooved on which said at least one projecting element can slide when said unit is operated.

20) The unit according to claim 19, wherein said annular body is provided with two or more longitudinal grooves having different lengths, on which said opposing element slides to define different quantities of fluid to be dispensed each time the unit is operated.

21) The unit according to claim 1, wherein said unit further comprises stopping means suited to define at least two extreme angular positions for said actuator element.

22) The unit according to claim 17 or 21, wherein said stopping means comprise third opposing elements cooperating with said first opposing elements.

23) The unit according to claim 22, wherein said third opposing elements comprise at least one vertical plane suited to counteract said opposing elements.

24) The unit according to claim 1, wherein said plungers comprises a support element to which a piston body is slidingly coupled, wherein said piston body sealingly cooperates with the walls of said at least one suction/compression chamber.

25) The unit according to claim 24, wherein said support element is provided with said second connection means.

26) The unit according to claim 1, wherein said second connection means comprise at least one annular edge.

27) The unit according to claim 1, wherein said first connection means comprise at least one annular seat.

28) The unit according to claim 1, wherein said unit also comprises elastic means suited to ensure the return of said plunger to the rest position once the fluid has been dispensed.

29) The unit according to claim 28, wherein said elastic means are arranged in said at least one suction/compression chamber.

30) The unit according to claim 28, wherein said elastic means are coaxial to said rod.

31) The unit according to claim 28, wherein said elastic means comprise a helical spring.

32) The unit according to claim 28, wherein said elastic means comprise an elastic bellows made of a plastic material.

33) The unit according to claim 1, wherein said at least one actuator element comprises a spout or nozzle removably connected to said rod.

34) The unit according to claim 1, wherein said rod is externally coupled to one end of said plunger.

35) A device for dispensing fluids, comprising a support element for a unit for dispensing a fluid, provided with means for connection to the neck of a container containing said fluid, wherein said at least one unit for dispensing fluids is carried out according to claim 1.

36) A device for dispensing fluids in the form of foam comprising:
a support element for a first unit for dispensing fluids and/or for a second unit for dispensing pressurized air, said support element being provided with means for fastening to the neck of a container containing said fluid;
at least one mixing chamber for the air and fluid dispensed by said units; and
means suited to facilitate the production of said foam positioned before the outlet of said device;
wherein at least one of said units for dispensing fluids is carried out according to claim 1.

37) The device according to claim 36, wherein said second unit comprises a collapsible chamber.

38) The device according to claim 37, wherein said collapsible chamber is delimited by an elastic bellows.

39) A system for dispensing a fluid or a mixture comprising a container for said fluid or mixture and a device for dispensing said fluid or mixture, wherein said device is carried out according to claim 35 or 36.

40) (canceled)
